(19) United States
(12) Patent Application Publication
(10) Pub. No.: US 2007/0042253 A1
(43) Pub. Date: Feb. 22, 2007

(54) Fuel cell unit

(75) Inventors: Uwe Maier, Reutlingen (DE); Wolfgang Fritz, Metzingen (DE)

Correspondence Address: Mr. Edward J. Timmer, P.O. Box 770, Richland, MI, 49083-0770, US

(73) Assignee: ElringKlinger AG

(21) Appl. No.: 11/486,766

(22) Filed: Jul. 14, 2006

(30) Foreign Application Priority Data
Jul. 18, 2005 (DE) 10 2005 034 616.2

(51) Int. Cl. H01M 2/02

(52) U.S. Cl. 429/34

(57) ABSTRACT

In order to produce a fuel cell unit comprising a cathode electrolyte anode unit and at least one contact element for making electrically conductive contact with the cathode electrolyte anode unit such that electrical contact with the KEA unit is producible in a reliable and simple manner, it is proposed that at least one contact element comprise a plate provided with a multiplicity of break-throughs.

### RELATED APPLICATION

The present disclosure relates to the item which was disclosed in the German patent application No. 10 2005 034 616.2 of 18 Jul. 2005. The entire description of this earlier application is incorporated by reference thereto as a constituent part of the present description (“incorporation by reference”).

### FIELD OF DISCLOSURE

The present invention relates to a fuel cell unit which comprises a cathode electrolyte anode unit (referred to for short hereinafter: KEA unit) and at least one contact element for making electrically conductive contact with the KEA unit.

### BACKGROUND

Such a fuel cell unit is known from DE 100 44 703 A1 for example, wherein such a contact element is in the form of a corrugated metal sheet contact field of a lower housing part of the fuel cell unit.

Furthermore, instead of a corrugated metal sheet, it is known to use a pimpled metal sheet for making contact with the KEA unit.

Furthermore, it is known to use a metallic net or a woven metal cloth for the purposes of making contact with the KEA unit.

In the case where corrugated metal sheets or pimpled metal sheets are used as contact elements, an extreme degree of deformation must be used for the production of the contact points which, for many materials, can lead to overstressing of the material, to fractures and to undefined and uneven formation of the contact points. Moreover, the region below the contact points is poorly supplied with fuel gas or oxidizing agent.

### SUMMARY OF THE INVENTION

Consequently, the object of the present invention is to produce a fuel cell unit wherein electrical contact with the KEA unit is producible in a reliable and simple manner.

In accordance with the invention, this object is achieved in the case of a fuel cell unit having the features of the preamble of Claim 1 in that at least one contact element comprises a plate provided with a multiplicity of break-throughs.

The contact element used in accordance with the invention rests directly or indirectly on the KEA unit (for example over a substrate of the KEA unit) in the region of the break-throughs, so that it is not necessary to create additional contact points in the form of corrugated peaks or pimples by a process of shaping a raw material.

Consequently, the contact element used in accordance with the invention is producible from a multiplicity of materials in a simple manner and enables the KEA unit to be contacted in a reliable manner.

Since the entire area between the break-throughs in the plate is available for the supply of fuel gas or an oxidizing agent, a particularly good supply of the gaseous reactants to the KEA unit is also ensured in the case of the fuel cell unit in accordance with the invention.

In a preferred embodiment of the invention, provision is made for at least some of the break-throughs to comprise a boundary portion projecting away from a major face of the contact element towards one side of the contact element. This boundary portion then forms a respective contact point for the electrically conductive contact between the contact element and the KEA unit or a substrate of the KEA unit.

It has proved to be particularly expedient for each of the boundary portions to take the form of a pointed crown.

Such pointed crowns can be produced by piercing the plate with a needle ground to a point.

Due to the presence of several points on the boundary portion of each break-through, several contact points between the contact element and the KEA unit or the substrate thereof are created per break-through, this thereby improving the electrical contact between these elements.

It is particularly expedient, if the pointed crowns each comprise three to six points, preferably if each comprises four points.

In particular, a crown with four points can be produced by piercing the plate with a needle ground into the shape of a pyramid.

The boundary portions of the break-throughs can all protrude at the same side of the contact element. In this case, the KEA unit is preferably arranged on that side of the contact element at which the boundary portions of the break-throughs protrude.

However, as an alternative thereto, provision could also be made for the boundary portions to protrude at two mutually opposite sides of the contact element.

Hereby, provision is preferably made for those break-throughs comprising boundary portions which project at a first side of the contact element to be arranged in a first lattice (i.e. in a periodic pattern) and for those break-throughs comprising boundary portions which protrude at the second side of the contact element opposite the first side to be arranged in a second lattice.

Hereby, the break-throughs of the second lattice are advantageously arranged in the spaces between the break-throughs of the first lattice.

It is particularly expedient, if each of the break-throughs of the second lattice is arranged substantially centrally between the neighboring break-throughs of the first lattice.

In principle, since the size of the break-throughs is freely selectable, arbitrarily long points and thus arbitrarily large projections of the boundary portions above the plate of the contact element can be produced, whereby the available space for the gas can be selected to be of any size.

The height of the projection of the boundary portions above the plate preferably amounts to from approximately 0.5 mm up to approximately 2 mm.

As seen in relation to the thickness of the plate, the height of the projection of the boundary portion above the plate preferably amounts to from approximately the single thickness of the plate up to approximately five times the thickness of the plate.

In order to ensure a good contact between the boundary portions on the one hand and the KEA unit or the substrate of the KEA unit on the other at all the contact points of the contact element, it is expedient if the height of the projection of the boundary portions above the plate is calibrated at a substantially uniform height.

Such a calibration can be effected in that the contact element is pressed between two plates having a defined spacing.

In a preferred embodiment of the invention, the contact element is in the form of a pointed plate.

The surface density of the break-throughs on the contact element preferably amounts to from approximately one break-through per cm² up to approximately 50 break-throughs per cm². In the case of such a surface density, there is a balanced relationship between there being as small a contact resistance as possible between the contact element and the KEA unit on the one hand whilst providing as good an accessibility to the KEA unit as possible for the fuel gas or the oxidizing agent.

The average distance between the center points of mutually neighboring break-throughs preferably amounts to approximately 1 mm up to approximately 5 mm.

The break-throughs are preferably arranged in a grid pattern, i.e. in a regular periodic arrangement.

In particular, provision may be made for the breakthroughs to be arranged in a square lattice or in a diamond lattice.

The plate of the contact element preferably has a material thickness of from approximately 0.1 mm up to approximately 0.5 mm.

The plate is preferably formed from a metallic material.

In particular, provision may be made for the plate to be formed from a steel material.

In order to enable long term use of the contact element in a high temperature fuel cell unit (SOFC fuel cell), the plate is preferably formed from a high temperature corrosion-resistant steel material. Such a material is corrosion resistant at the high operating temperatures of an SOFC fuel cell which are in the range of 800° C. to 900° C.

The contact element can be inserted loosely between the KEA unit and a housing-part of a housing of the fuel cell unit.

As an alternative thereto, it is also possible to fix the contact element to a housing-part of a housing of the fuel cell unit.

In particular hereby, provision may be made for the contact element to be soldered and/or welded to a housing-part of a housing of the fuel cell unit.

Moreover, for the purposes of improving the electrical contact between the contact element and the KEA unit and/or the housing-part of the fuel cell unit, provision may be made for a contact paste to be arranged between the contact element on the one hand and the KEA unit and/or a substrate of the KEA unit and/or the housing-part of the fuel cell unit on the other.

In particular, for the purposes of making contact with an anode-side contact element, a contact paste which contains nickel or nickel oxide can be used.

In particular, for the purposes of making contact with a cathode-side contact element, a contact paste which contains a material corresponding to the material of the cathode can be used, thus for example, lanthanum strontium manganate.

In a preferred embodiment of the fuel cell unit, provision is made for at least one contact element to be arranged on the anode side of the cathode electrolyte anode unit.

As an alternative or in addition thereto, provision may be made for at least one contact element to be arranged on the cathode side of the cathode electrolyte anode unit.

Claim 27 is directed towards a fuel cell stack which comprises a plurality of fuel cell units in accordance with the invention which succeed one another in the direction of the stack.

The contact element of the fuel cell unit in accordance with the invention provides a current pick-up means on the anode and/or on the cathode side of the KEA unit which offers as small a contact resistances as possible and which, at the same time, enables the fuel gas or the oxidizing agent to flow past whilst supplying the KEA unit with the gaseous reactants in as trouble-free a manner as possible.

The fuel cell unit in accordance with the invention is preferably in the form of a high temperature fuel cell unit (SOFC fuel cell) having an operating temperature in the range of approximately 800° C. to approximately 900° C. for example.

Further features and advantages of the invention form the subject matter of the following description and the graphic illustration of exemplary embodiments.

In the drawings:

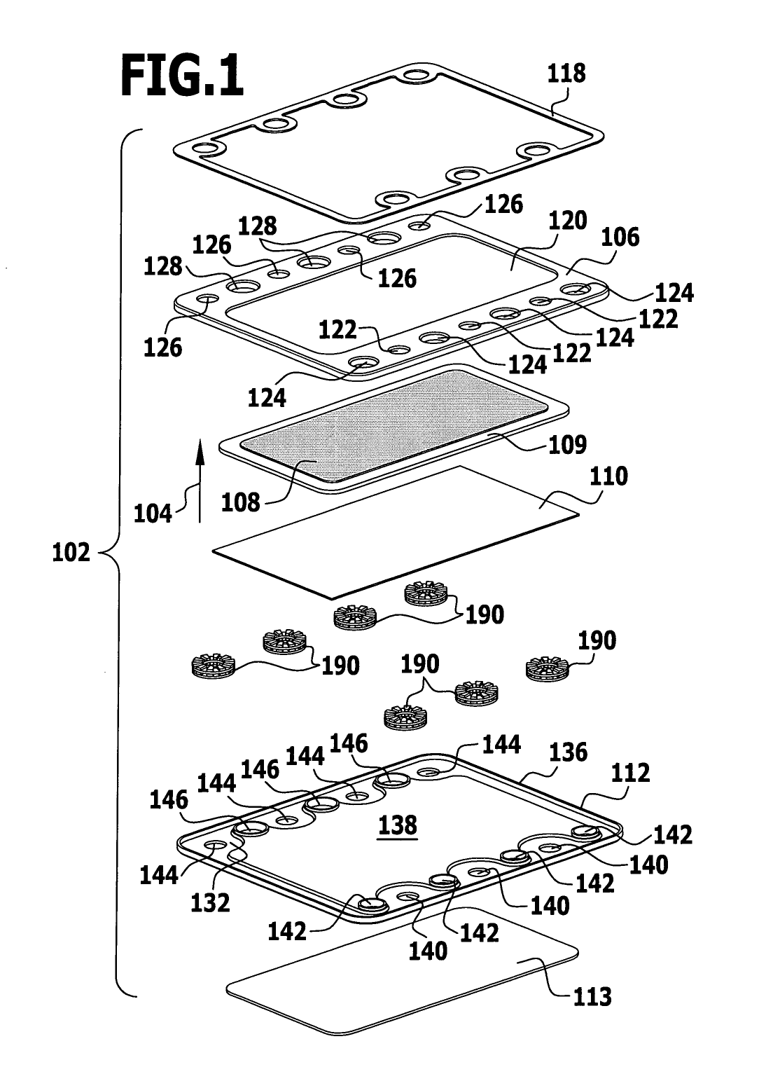

FIG. 1 shows a schematic exploded illustration of the elements of a fuel cell unit;

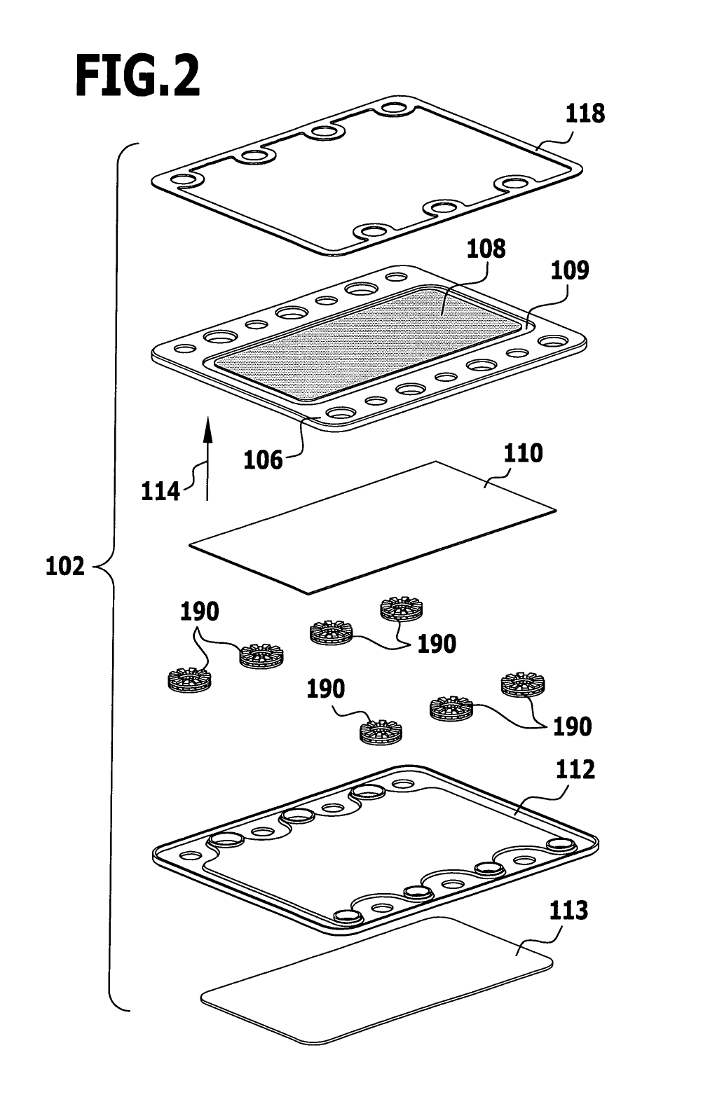

FIG. 2 a schematic exploded illustration of the fuel cell unit of FIG. 1, after a substrate of a KEA (Cathode Electrolyte Anode) unit of the fuel cell unit has been soldered to an upper housing part of the fuel cell unit;

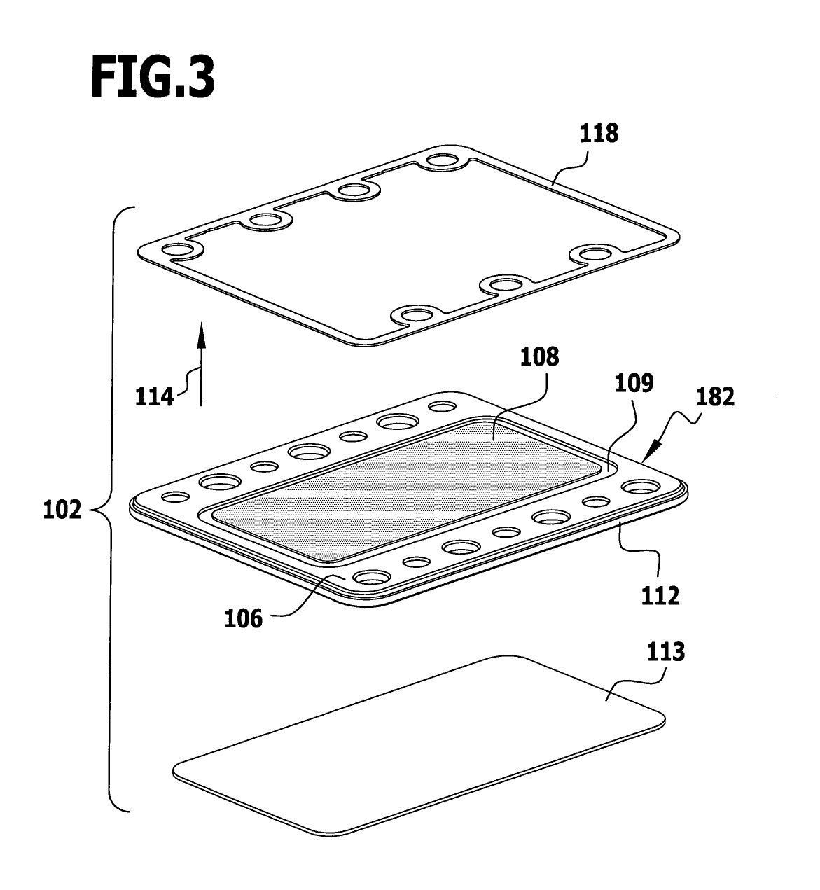

FIG. 3 a schematic exploded illustration of the fuel cell unit of FIG. 2, after the upper housing part and a lower housing part of the fuel cell unit have been welded together;

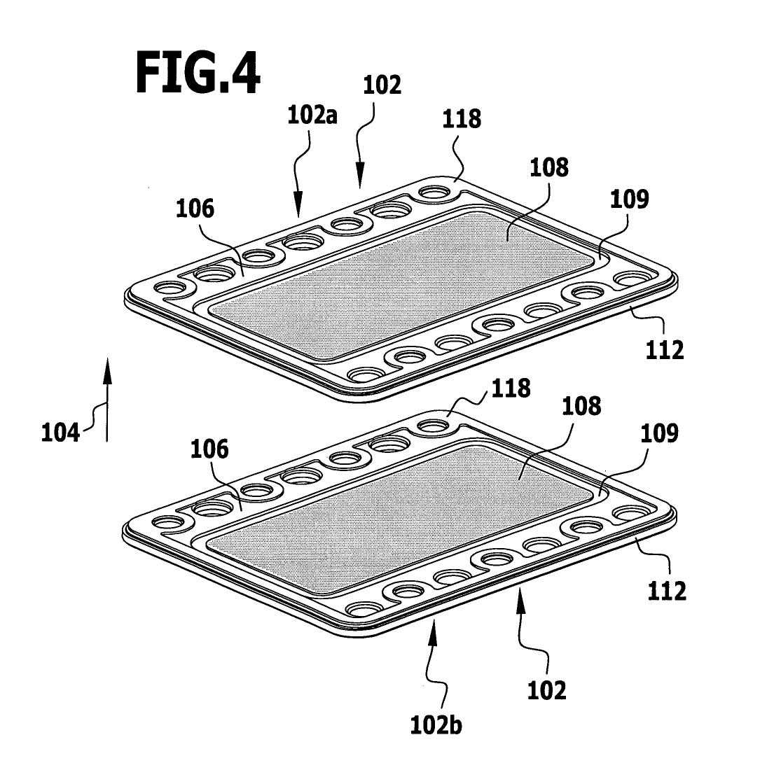

FIG. 4 a schematic perspective illustration of two fuel cell units of identical construction located successively in the direction of the stack of a stack of fuel cells;

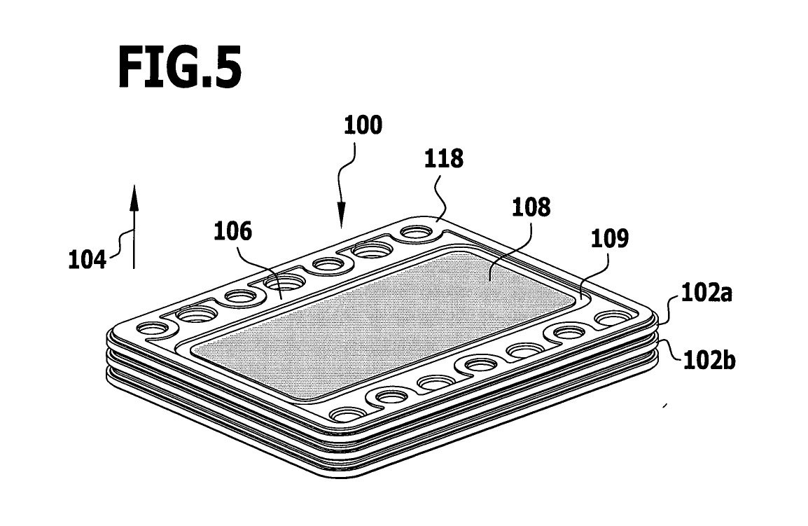

FIG. 5 a schematic perspective illustration of the two fuel cell units of FIG. 4, after they have been soldered to one another;

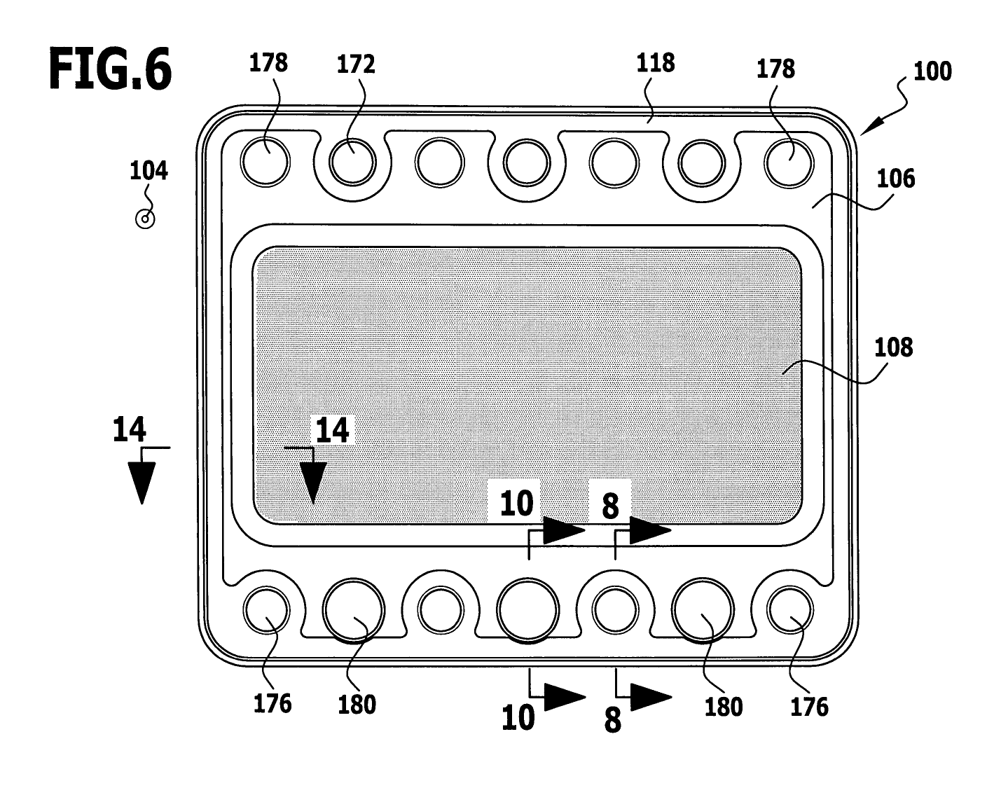

FIG. 6 a schematic plan view from above of a fuel cell stack;

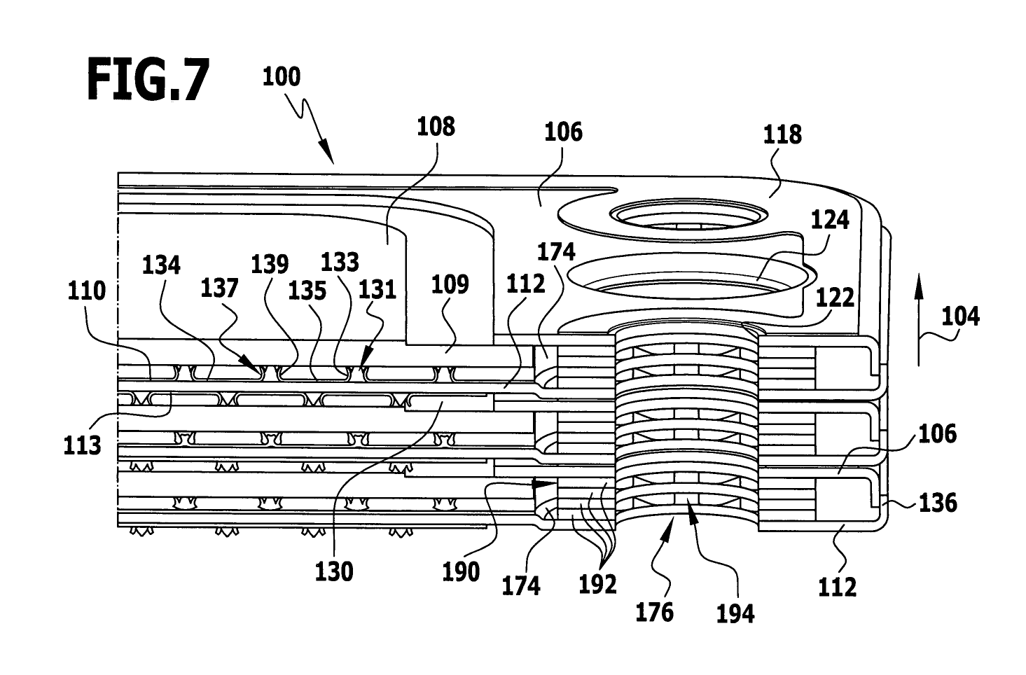

FIG. 7 a detailed partially sectional perspective view of the fuel cell stack in the region of a fuel gas channel;

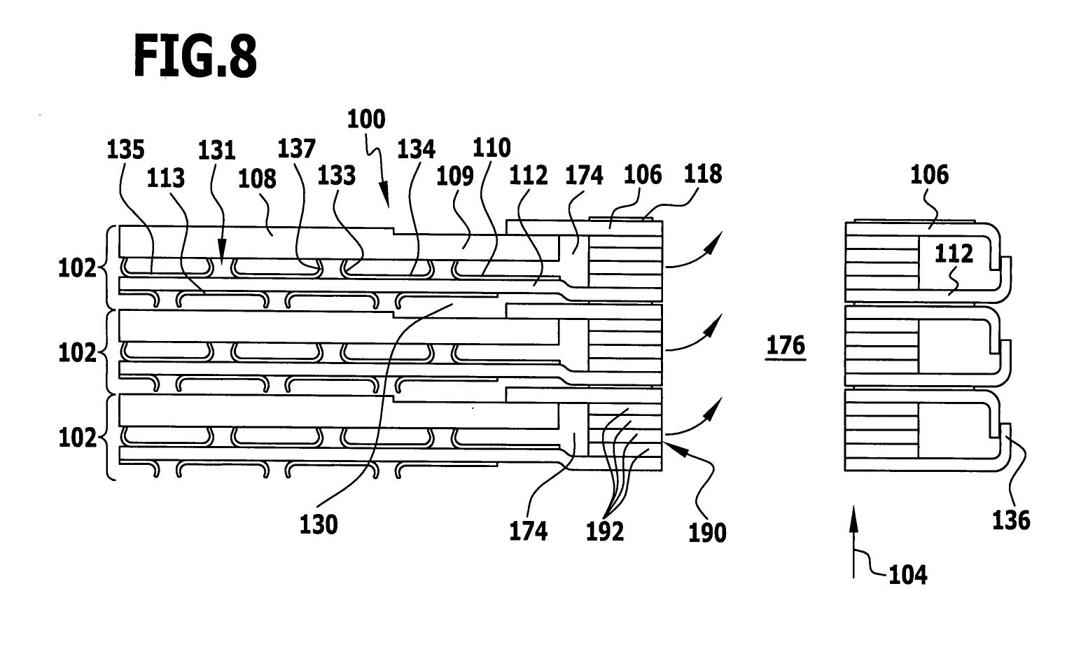

FIG. 8 a schematic vertical section through the fuel cell stack in the region of a fuel gas channel, along the line 8-8 in FIG. 6;

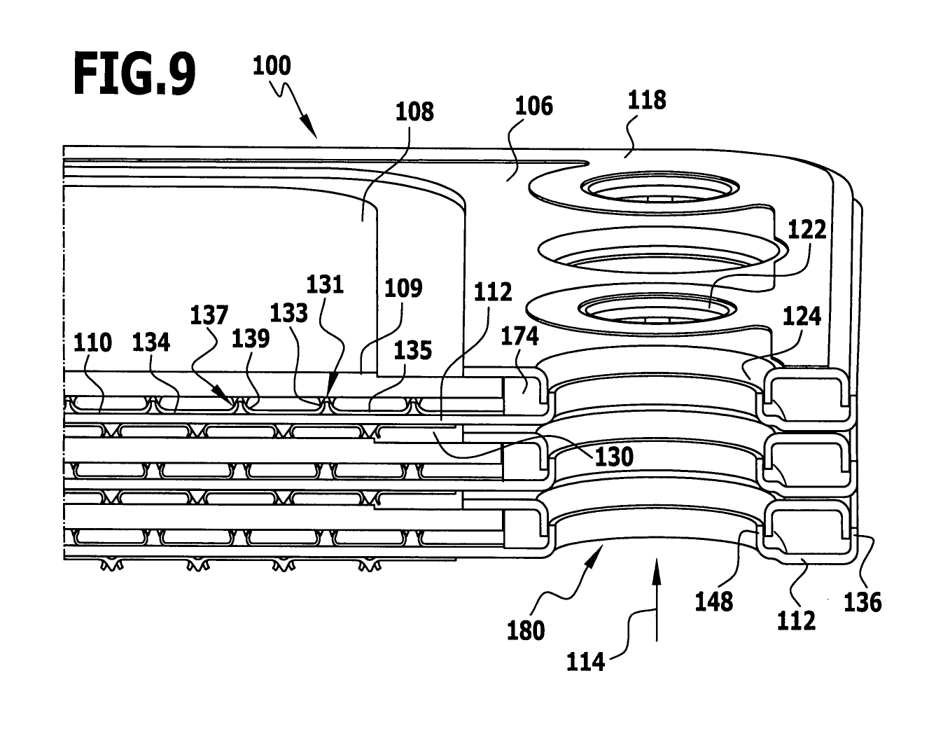

FIG. 9 a detailed partially sectional perspective illustration of the fuel cell stack in the region of an oxidizing agent channel;

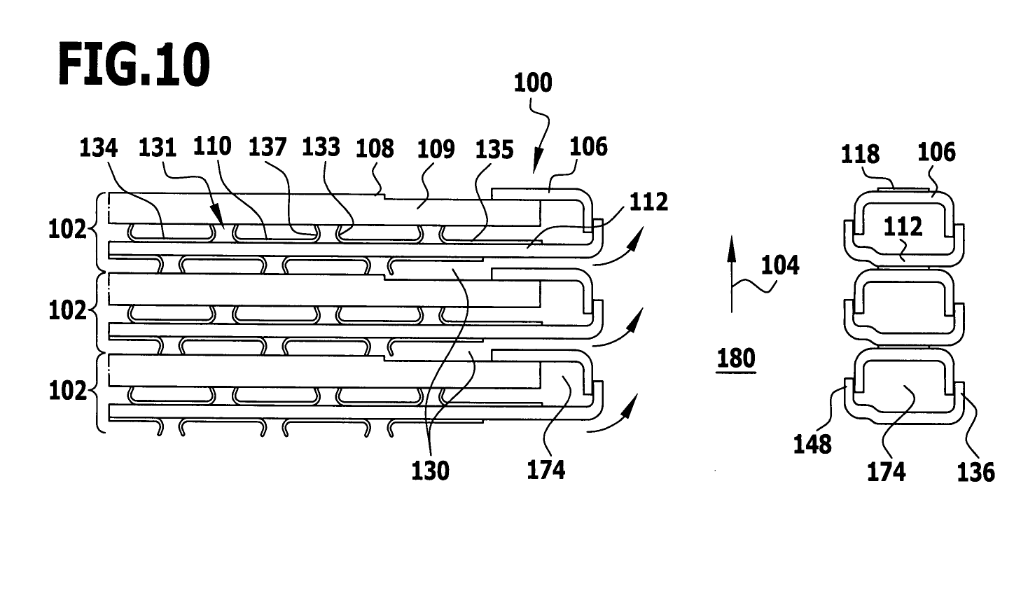

FIG. 10 a schematic vertical section through the fuel cell stack in the region of an oxidizing agent channel, along the line 10-10 in FIG. 6;

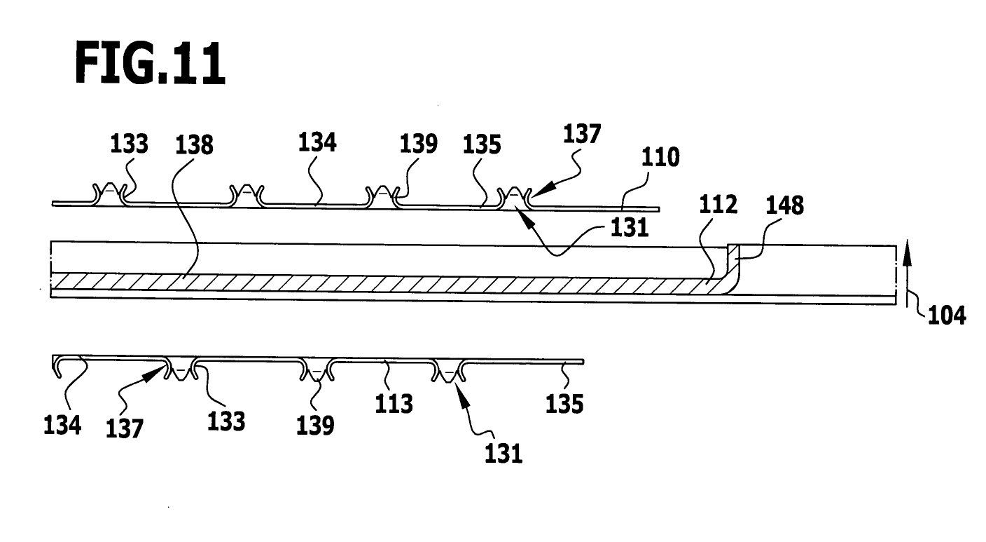

FIG. 11 a detailed schematic exploded illustration which illustrates a section through the lower housing part of a fuel cell unit, the neighboring anode-side contact element and the neighboring cathode-side contact element;

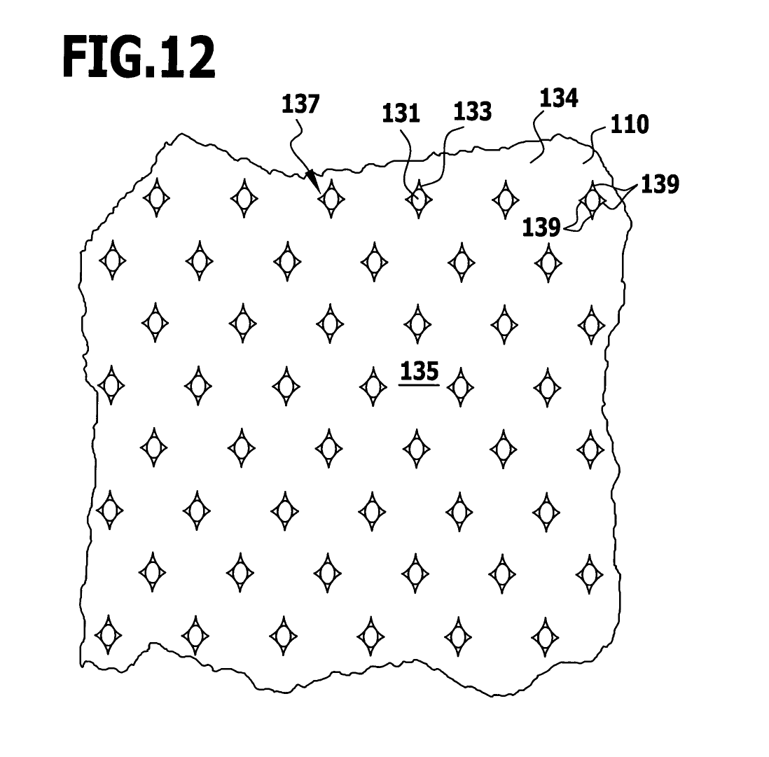

FIG. 12 a schematic plan view of the side of a contact element that is in the form of a pointed plate provided with pointed crowns;

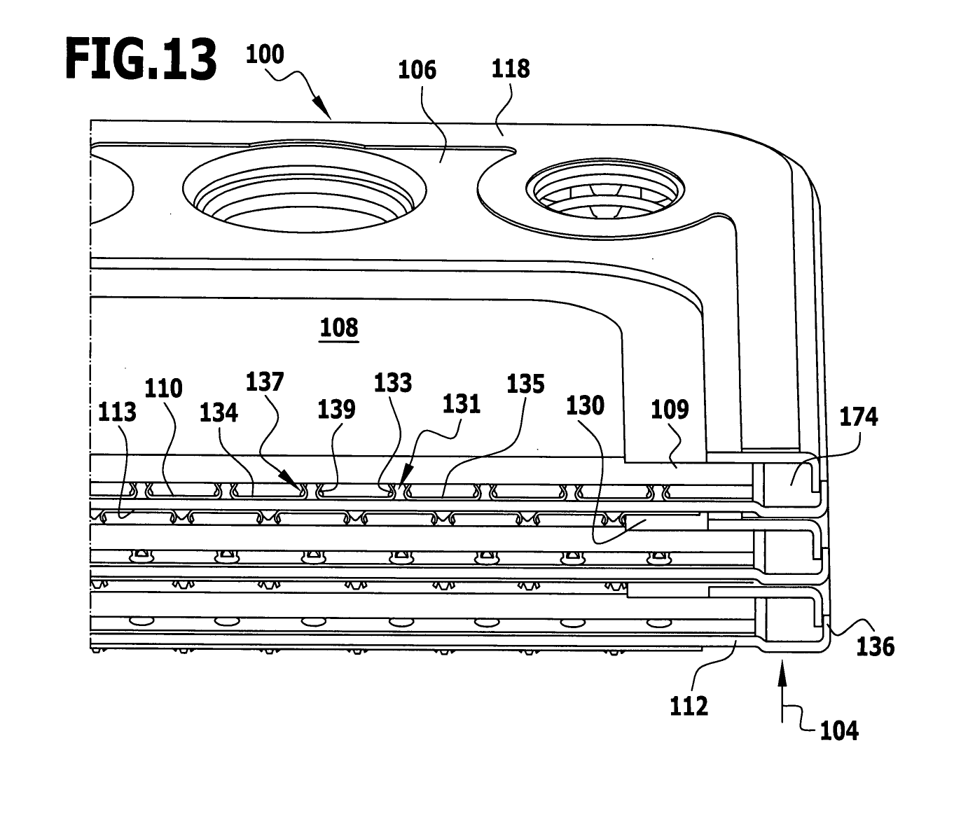

FIG. 13 a detailed partially sectional perspective illustration of the fuel cell stack in a region outside the fluid channels;

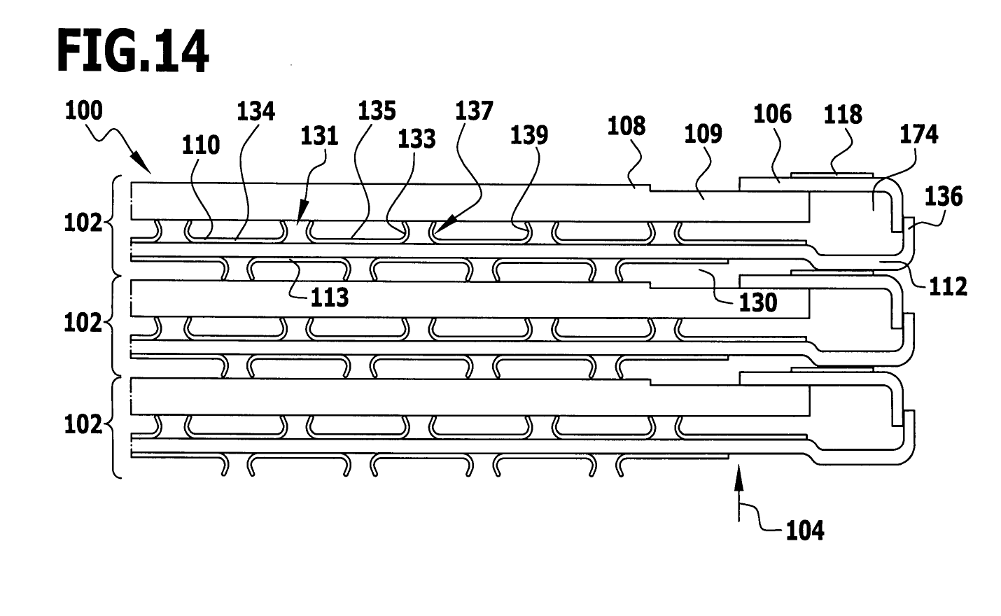

FIG. 14 a schematic vertical section through the fuel cell stack in a region outside the fluid channels, along the line 14-14 in FIG. 6; and

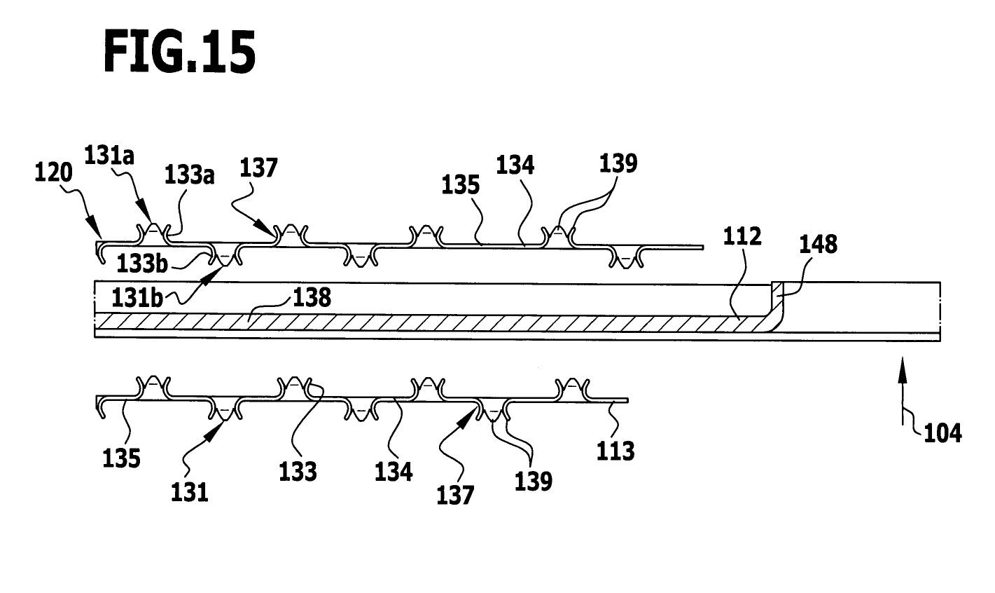

FIG. 15 a detailed exploded illustration of a second embodiment of a fuel cell unit corresponding to FIG. 11, wherein the contact elements are in the form of pointed plates that are provided with pointed crowns on each side.

Similar or functionally equivalent elements are designated by the same reference symbols in all the Figures.

A fuel cell stack bearing the general reference 100 that is illustrated in FIGS. 5 to 14 comprises several fuel cell units 102 of respectively identical construction which are stacked one on top of the other along the vertical stack direction 104.

Each of the fuel cell units 102 comprises the components illustrated individually in FIG. 1, namely, an upper housing part 106, a cathode electrolyte anode unit (KEA unit) 108 on a substrate 109, an anode-side contact element 110, a lower housing part 112, a cathode-side contact element 113 and spacer rings 190.

Furthermore, a sealing device 118, a solder glass layer for example, for connecting the upper housing part 106 to the lower housing part 112 of a fuel cell unit 102 located thereabove in the stack direction 104 in a gas-tight and electrically insulating manner is illustrated in FIG. 1.

The upper housing part 106 is in the form of a substantially rectangular and substantially flat metal sheet which is provided with a substantially rectangular central passage opening 120 through which, in the fully assembled state of the fuel cell unit, the KEA unit 108 of the fuel cell unit 102 is accessible for the purposes of making contact with the cathode-side contact element 113 of the fuel cell unit 102 located thereabove in the stack direction 104.

On the one side of the passage opening 120, the upper housing part 106 is provided with several, three for example, fuel gas supply openings 122 which are arranged to alternate with several, four for example, oxidizing agent supply openings 124.

On the opposite side of the passage opening 120, the upper housing part 106 is provided with several, four for example, fuel gas removal openings 126 which are arranged to alternate with several, three for example, oxidizing agent removal openings 128.

The upper housing part 106 is preferably made of a highly corrosion resistant steel, for example, from the alloy Crofer 22.

The material Crofer 22 has the following composition:

22 percentage weight chrome, 0.6 percentage weight aluminum, 0.3 percentage weight silicon, 0.45 percentage weight manganese, 0.08 percentage weight titanium, 0.08 percentage weight lanthanum, the remainder iron.

This material is sold by the company ThyssenKrupp VDM GmbH, Plettenberger Straβe 2, 58791 Werdohl, Germany.

The KEA unit 108 comprises an anode which is arranged directly on the upper surface of the substrate 109, an electrolyte which is arranged above the anode and a cathode which is arranged above the electrolyte, wherein these individual layers of the KEA unit 108 are not illustrated separately in the drawings.

The anode is formed from a ceramic material, from ZrO₂ or from a Ni/ZrO₂-Cermet (ceramic metal mixture) for example, which is electrically conductive at the operating temperature of the fuel cell unit (from approximately 800° C. to approximately 900° C.), and is porous in order to enable the fuel gas passing through the substrate 109 to pass on through the anode to the electrolyte adjoining the anode.

A hydrocarbon-containing gas mixture or pure hydrogen can be used as the fuel gas for example.

The electrolyte is preferably in the form of a solid electrolyte, in particular, a solid oxide electrolyte, and consists of yttrium-stabilized zirconium dioxide for example.

The electrolyte is electronically non-conductive at normal temperatures and also at the operating temperature. By contrast however, the ionic conductivity thereof rises with increasing temperature.

The cathode is formed from a ceramic material which is electrically conductive at the operating temperature of the fuel cell unit, for example, from (La_{0.8}Sr_{0.2})_{0.98}MnO₃, and it is porous in order to enable an oxidizing agent, air or pure oxygen for example, to pass to the electrolyte from an oxidizing agent chamber 130 adjoining the cathode.

The edge of the substantially parallelepiped substrate 109 extends beyond the edge of the KEA unit 108.

The gas-tight electrolyte of the KEA unit 108 extends beyond the edge of the gas-permeable anode and beyond the edge of the gas-permeable cathode and the lower surface thereof rests directly on the upper surface of the boundary portion region of the substrate 109.

The substrate 109 may, for example, be in the form of a porous sintered body consisting of sintered metal particles.

The anode-side contact element 110, which is arranged between the substrate 109 and the lower housing part 112, is in the form of a pointed plate, i.e. it is in the form of a substantially flat plate 134 comprising a multiplicity of break-throughs 131 which are surrounded by a respective boundary portion 133 in the form of a pointed crown 137 that projects from a flat upper surface 135 of the plate 134 on the side of the substrate 109 (see in particular, FIGS. 11 and 12).

As can best be seen from FIG. 12, the break-throughs 131 are arranged in a regular pattern on the anode-side contact element 110, for example, in a diamond lattice.

The pointed plate used as an anode-side contact element 110 is formed from a metallic sheet-metal material, preferably from a high temperature corrosion-resistant ferrite material, such as from the material 1.4760 (CroFer) or from the material 1.4772 for example, or made of a highly ductile austenitic high-grade steel, such as from the material 1.4016 for example (all of the aforesaid material designations are in accordance with the standard EN 10 088-2).

The austenitic high-grade steel bearing the material designation 1.4016 has the following chemical composition: 16.0 weight % to 18.0 weight % Cr; maximally 0.08 weight % C; the remainder iron.

The breakthroughs 131 comprising the pointed crowns 137 are produced in a metal sheet made from one of the aforesaid materials in that the metal sheet is pierced from one side by a needle-like tool which comprises a multiplicity of pyramid-shaped ground needles in the desired arrangement of the break-throughs 131 that are to be produced.

Due to the pyramid shape of the needles used for the piercing process, crowns each having four points 139 are thereby formed.

In principle however, needles having some other number of side faces can be used, this then leading to pointed crowns 137 having a correspondingly different number of points 139.

The tool for piercing the metal sheet can be in the form of a substantially flat needle plate.

As an alternatively thereto, provision could also be made for the raw material to be drawn over a roller which, for example, is provided with the pyramid-shaped ground needles for the purposes of piercing the raw material.

The surface density of the break-throughs 131 on the pointed plate produced in such a manner preferably amounts to from approximately one break-through per cm² to approximately 50 break-throughs per cm².

The distance between the center points of mutually neighboring break-throughs 131 preferably amounts to from approximately 1 mm to approximately 5 mm.

The thickness of the raw material used for the pointed plate preferably amounts to approximately 0.1 mm up to approximately 0.5 mm.

The formed height of the pointed crowns 137, i.e. the amount by which they project above the upper surface 135 of the plate 134 preferably amounts to approximately 0.5 mm up to approximately 2 mm.

The height of this projection is accurately set by means of a calibration process wherein the pointed plate is compressed between two plates having distance-pieces located therebetween, the height of said distance-pieces corresponding to the sum of the material thickness of the raw material and the desired amount of projection.

The pointed plate manufactured in such a manner is arranged as the anode-side contact element 110 between the upper surface of the lower housing part 112 and the lower surface of the substrate 109 so that the pointed crowns 137 of the pointed plate are in intimate contact with the substrate 109. In particular, provision may be made for the points 139 of the pointed plate to dig themselves into the substrate 109.

The anode-side contact element 110 can be inserted loosely between the lower housing part 112 and the substrate 109.

As an alternative thereto, provision may also be made for the anode-side contact element 110 to be welded to the lower housing part 112, for example, by means of a laser or capacitor discharge welding process.

Furthermore, as an alternative or in addition thereto, provision may be made for the anode-side contact element 110 to be soldered to the lower housing part 112, for example, by means of a metallic solder, in particular, a silver-based solder or a copper-based solder.

The anode-side contact element 110 represents a highly electrically conductive connection between the electrically conductive substrate 109 and thus the anode located on the substrate 109 on the one hand and the electrically conductive lower housing part 112 of the fuel cell unit 102 on the other, and thus provides a current pick-up means on the anode side of the KEA unit 108.

The lower housing part 112 is in the form of a sheet metal shaped-part and comprises a substantially rectangular plate 132 which is directed perpendicularly to the stack direction 104, whilst the edges thereof merge into an edge flange 136 that is aligned substantially parallel to the stack direction 104.

The plate 132 comprises a substantially rectangular central contact field 138 which is in electrically conductive contact with the anode-side contact element 110 on the one hand and with the cathode-side contact element 113 on the other.

On the one side of the contact field 138, the plate 132 is provided with a plurality of, three for example, fuel gas supply openings 140 which are arranged to alternate with a plurality of, four for example, oxidizing agent supply openings 142.

The fuel gas supply openings 140 and the oxidizing agent supply openings 142 of the lower housing part 112 are in alignment with the respective fuel gas supply openings 122 and the oxidizing agent supply openings 124 of the upper housing part 106.

On the other side of the contact field 138, the plate 132 is provided with a plurality of, four for example, fuel gas supply openings 144 which are arranged to alternate with a plurality of, three for example, oxidizing agent removal openings 146.

The fuel gas removal openings 144 and the oxidizing agent removal openings 146 of the lower housing part 112 are in alignment with the respective fuel gas removal openings 126 and the oxidizing agent removal openings 128 of the upper housing part 106.

The oxidizing agent removal openings 146 are preferably located opposite the fuel gas supply openings 140, and the fuel gas removal openings 144 are preferably located opposite the oxidizing agent supply openings 142.

As can best be seen from FIGS. 11 to 13, the oxidizing agent removal openings 146 (in like manner to the oxidizing agent supply openings 142) of the lower housing part 112 are each surrounded by a ring flange 148 which surrounds the opening concerned in ring-like manner and is aligned substantially parallel to the stack direction 104.

The lower housing part 112 is preferably made of a highly corrosion resistant steel, for example, from the previously mentioned alloy Crofer 22.

The cathode-side contact element 113 that is arranged between the lower surface of the lower housing part 112 and the upper surface of the cathode of a fuel cell unit 102 located therebelow in the stack direction 104 is in the form of a pointed plate in like manner to the anode-side contact element 110.

The design and manner of production of the pointed plate serving as a cathode-side contact element 113 is in agreement with the design and manner of production of the pointed plate used as an anode-side contact element 110, and to this extent, reference should be made to the preceding description.

The cathode-side contact element 113 is arranged between the lower housing part 112 of a fuel cell unit 102 and the KEA unit 108 of a fuel cell unit located therebelow in the stack direction 104 in such a way that the flat upper surface of the cathode-side contact element 113 rests in laminar manner against the lower surface of the lower housing part 112 and is in intimate contact with the cathode of the underlying KEA unit 108 by virtue of its pointed crowns 137. In particular, provision may be made for the points 139 of the cathode-side contact element 113 to entrench themselves into the cathode of the underlying KEA unit 108.

The cathode-side contact element 113 can be inserted loosely between the lower housing part 112 and the KEA unit 108 of the underlying fuel cell unit 102.

As an alternative thereto, provision may also be made for the cathode-side contact element 113 to be welded to the lower housing part 112, for example, by means of a laser or capacitor discharge welding process.

As an alternative or in addition thereto, provision may also be made for the cathode-side contact element 113 to be soldered to the lower housing part 112. For this purpose, a metallic solder, for example, a silver based solder or a copper based solder, is preferably used.

The cathode-side contact element 113 in the form of a pointed plate represents an electrically conductive connection between the electrically conductive lower housing part 112 on the one hand and the cathode of the KEA unit 108 of the fuel cell unit 102 located therebelow in the stack direction 104 on the other, thereby providing a current pick-up means on the cathode side of the underlying KEA unit 108.

For reasons of clarity in the schematic illustrations of FIGS. 1 to 3, both the anode-side contact element 110 and the cathode-side contact element 113 are illustrated without the respective pointed crowns 137.

The sealing device 118 comprises a layer consisting of a glass solder material that is electrically insulating and gastight at the operating temperature of the fuel cell and which is deposited on the upper surface of the upper housing part 106, in the boundary portion region and around the fuel gas removal openings 122 and around the fuel gas removal openings 126.

A suitable glass solder is disclosed in EP 0 907 215 A1 for example, and it contains 11 to 13 weight % aluminium oxide (Al₂O₃), 10 to 14 weight % boron oxide (BO₂), about 5 weight % calcium oxide (CaO), 23 to 26 weight % barium oxide (BaO) and about 50 weight % silicon oxide (SiO₂).

Furthermore, for the purposes of mechanical stabilization of the fuel cell unit 102, there are provided spacer rings 190 which are arranged between the upper housing part 106 and the lower housing part 112 of the fuel cell unit 102 in the region of the fuel gas supply openings 122 and 140 and in the region of the fuel gas removal openings 126 and 144 in order to maintain a mutual spacing between the upper housing part 106 and the lower housing part 112 in this region.

Each of the spacer rings 190 consists of several superimposed metal layers 192, and fuel gas passage channels 194 that are formed by recesses in the metal layers 192 enable the fuel gas to pass through the spacer rings 190.

For the purposes of producing the fuel cell units 102 which are illustrated in FIG. 4 and which consist of the previously described individual components, one proceeds as follows:

Firstly, the substrate 109 upon which the KEA unit 108 is located is soldered along the edge of its upper surface to the upper housing part 106, namely, to the lower surface of the region of the upper housing part 106 surrounding the passage opening 120 in the upper housing part 106.

The soldering material needed for this purpose can be inserted between the substrate 109 and the upper housing part 106 in the form of a suitably cut soldering foil or else it could be deposited on the upper surface of the substrate 109 and/or on the lower surface of the upper housing part 106 in the form of a bead of soldering material by means of a dispenser. Furthermore, it is also possible for the soldering material to be applied to the upper surface of the substrate 109 and/or the lower surface of the upper housing part 106 by means of a pattern printing process, for example, a silk-screen printing process.

A silver based solder incorporating a copper additive, for example a silver based solder with the composition (in mol of %): Ag4Cu or Ag8Cu can be used as the soldering material.

The soldering process takes place in an air atmosphere. The soldering temperature amounts to

1050° C. for example, the duration of the soldering process is approximately 5 minutes for example. When the soldering process is effected in air, copper oxide forms in situ.

As an alternative thereto, a silver based solder without a copper additive could also be used as the soldering material. Such a copper-free solder offers the advantage of a higher solidus temperature (this amounts to approximately 960° C. without a copper additive, to approximately 780° C. with a copper additive). Since pure silver does not wet ceramic surfaces, copper(II)oxide is added to those silver based solders without a copper additive for the purposes of reducing the edge angle. The soldering process utilising silver based solders without a copper additive takes place in an air atmosphere or in an inert gas atmosphere, for example, under argon.

In this case too, the soldering temperature preferably amounts to approximately 1050° C., the duration of the soldering process to approximately 5 minutes for example.

As an alternative to soldering the substrate 109 with the KEA unit 108 arranged thereon into the upper housing part 106, provision could also be made for a substrate 109 upon which the KEA unit 108 has not yet been produced to be welded to the upper housing part 106 and, following the welding process, the electro-chemically active layers of the KEA unit 108, i.e. the anode, electrolyte and cathode thereof, are produced successively on the substrate 109 that has already been welded to the upper housing part 106 using a vacuum plasma spraying process.

After the connection of the substrate 109 to the upper housing part 106, the state illustrated in FIG. 2 is reached.

Subsequently, the anode-side contact element 110 and the spacer rings 190 are inserted between the lower housing part 112 and the upper housing part 106 and are soldered and/or welded if necessary to the lower housing part 112 and/or to the upper housing part 106, and then the lower housing part 112 and the upper housing part 106 are welded together in gas-tight manner along a welding seam which extends around the outer edge of the edge flange 136 of the lower housing part 112 and the outer edge of the upper housing part 106 and along welding seams which extend around the inner edges of the ring flanges 148 of the lower housing part 112 and the edges of the oxidizing agent supply openings 124 and the oxidizing agent removal openings 128 of the upper housing part 106.

Following this method step, the state illustrated in FIG. 3 is reached.

Then, the cathode-side contact element 113 is now connected to the lower surface of the lower housing part 112 by a welding and/or soldering process for example.

Furthermore, the sealing device 118 made of a glass solder material is applied to the upper surface of the upper housing part 106.

Following this method step, the state illustrated in FIG. 4 is reached wherein there are now fully assembled fuel cell units 102 but these still need to be connected together in order to form a fuel cell stack 100 consisting of a plurality of fuel cell units 102 which succeed one another in the stack direction 104.

The connection of two fuel cell units 102 which succeed one another in the stack direction 104 is effected by soldering a respective upper housing part 106 to the lower housing part 112 of the fuel cell unit located thereabove in the stack direction 104 by means of the glass solder material of the sealing device 118 applied to the upper housing part 106.

After two fuel cell units 102 have been connected together in this way, the fuel cell stack 100 can be gradually built up by successively adding further fuel cell units 102 to the lower housing part 112 of the lower fuel cell unit 102b or to the upper housing part 106 of the upper fuel cell unit 102a in the stack direction 104 until the desired number of fuel cell units 102 is attained.

In the finished fuel cell stack 100, the respective mutually aligned fuel gas supply openings 122 and 140 of the upper housing parts 106 and the lower housing parts 112 form a respective fuel gas supply channel 172 which, in each fuel cell unit 102, opens through the respectively associated spacer ring 190 between the upper surface of the lower housing part 112 and the lower surface of the upper housing part 106 into a fuel gas chamber 174 which is formed between the upper surface of the lower housing part 112 on the one hand and the lower surface of the substrate 109 of the KEA unit 108 on the other.

The respective mutually aligned fuel gas removal openings 126 and 144 of the upper housing parts 106 and the lower housing parts 112 form a respective fuel gas removal channel 176 which is open to the fuel gas chamber 174 through the respectively associated spacer ring 190 in the region between the upper surface of the lower housing part 112 and the lower surface of the upper housing part 106 on the side of each fuel cell unit 102 located opposite the fuel gas supply channels 172.

The respective mutually aligned oxidizing agent supply openings 124 and 142 of the upper housing parts 106 and the lower housing parts 112 together form a respective oxidizing agent supply channel 178 which is open to the oxidizing agent chamber 130 of the fuel cell unit 102 in the region of each fuel cell unit 102 between the upper surface of the upper housing part 106 and the lower surface of the lower housing part 112 of the fuel cell unit 102 located thereabove in the stack direction 104.

In like manner, the respective mutually aligned oxidizing agent removal openings 128 and 146 of the upper housing parts 106 and the lower housing parts 112 form a respective oxidizing agent removal channel 180 which is arranged on the side of the fuel cell units 102 located opposite to the oxidizing agent supply channels 178 and likewise opens into the oxidizing agent chamber 130 of the fuel cell unit 102 in the region of each fuel cell unit 102 between the upper surface of the upper housing part 106 and the lower surface of the lower housing part 112 of the fuel cell unit 102 located thereabove it in the stack direction 104.

In operation of the fuel cell stack 100, a fuel gas is supplied to the fuel gas chamber 174 of each fuel cell unit 102 by way of the fuel gas supply channels 172 and the exhaust gas produced by oxidation at the anode of the KEA unit 108 as well as any unused fuel gas is removed from the fuel gas chamber 174 through the fuel gas removal channels 176.

In like manner, an oxidizing agent, air for example, is supplied to the oxidizing agent chamber 130 of each fuel cell unit 102 through the oxidizing agent supply channels 178 and unused oxidizing agent is removed from the oxidizing agent chamber 130 through the oxidizing agent removal channels 180.

In operation of the fuel cell stack 100, the KEA units 108 are, for example, at a temperature of 850° C. at which the electrolyte of each KEA unit 108 is conductive for oxygen ions. The oxidizing agent from the oxidizing agent chamber 130 picks up electrons at the cathode and delivers doubly negatively charged oxygen ions to the electrolyte, said ions then migrating through the electrolyte to the anode. At the anode, the fuel gas from the fuel gas chamber 174 is oxidized by the oxygen ions from the electrolyte and thereby donates electrons to the anode.

The electrons freed by the reaction at the anode are supplied by way of the substrate 109, the anode-side contact element 110, the lower housing part 112 and the cathode-side contact element 113 to the cathode of a neighboring fuel cell unit 102 resting on the lower surface of the cathode-side contact element 113 and thus make the cathode reaction possible.

The lower housing part 112 and the upper housing part 106 of each fuel cell unit 102 are connected together in electrically conductive manner by the previously described welding seams.

However, the housings 182 of the fuel cell units 102 which succeed one another in the stack direction 104 that are formed in each case by an upper housing part 106 and a lower housing part 112 are electrically insulated from one another by the sealing devices 118 between the upper surface of the upper housing parts 106 and the lower surface of the lower housing parts 112.

At the same time hereby, a gas-tight connection between these elements is ensured by the sealing devices 118 so that the oxidizing agent chambers 130 and the fuel gas chambers 174 of the fuel cell units 102 are separated from one another and from the environment of the fuel cell stack 100 in gas-tight manner.

A second embodiment of a fuel cell unit 102 in accordance with the invention that is illustrated in FIG. 15 differs from the first embodiment illustrated in FIGS. 1 to 14 only in that the boundary portions 133 of the break-throughs 131 in the anode-side contact element 110 and in the cathode-side contact element 113 do not all project at the same side of the respective contact element 110 or 113, but rather, at mutually opposite sides of the respective contact element 110 or 113 so that the plates 134 of the contact elements 110 and 113 are provided with pointed crowns 137 on each side thereof.

The break-throughs 131a whose respective boundary portions 133a project towards the KEA unit 108 form a first lattice of break-throughs 131a, whilst the break-throughs 131b whose boundary portions 131b project towards the lower housing part 112 form a second lattice of break-throughs 131b, wherein the respective break-throughs 131b of the second lattice are arranged substantially centrally between the respective neighboring break-throughs 131a of the first lattice.

The pointed plates of the contact elements 110, 113 that are pointed on each side thereof in this second embodiment are produced by piercing a raw material, in succession from the two different sides of the raw material, with a needle-like tool which comprises ground needles.

The anode-side contact element 110 is inserted between the substrate 109 and the lower housing part 112, and the cathode-side contact element 113 is inserted between the lower housing part 112 and the KEA unit 108 of the fuel cell unit 102 located therebelow in the stack direction 104.

In this way, the anode-side contact element 110 provides a current pick-up means on the anode side of the KEA unit 108, and the cathode-side contact element 113 provides a current pick-up means on the cathode side of the KEA unit 108 of the fuel cell unit 102 located therebelow in the stack direction 104.

In all other respects, the second embodiment of a fuel cell unit that is illustrated in FIG. 15 is identical with the first embodiment illustrated in FIGS. 1 to 14 in regard to the construction and functioning thereof, and to that extent, reference may be made to the previous description thereof.

1. A fuel cell unit comprising a cathode electrolyte anode unit and at least one contact element for making electrically conductive contact with the cathode electrolyte anode unit,
wherein at least one contact element comprises a plate provided with a multiplicity of break-throughs.

2. A fuel cell unit in accordance with claim 1, wherein at least some of the breakthroughs comprise a boundary portion protruding away from a major face of the contact element towards one side of the contact element.

3. A fuel cell unit in accordance with claim 2, wherein each of the boundary portions takes the form of a pointed crown.

4. A fuel cell unit in accordance with claim 3, wherein the pointed crowns each comprise three to six points, preferably each comprises four points.

5. A fuel cell unit in accordance with claim 2, wherein the boundary portions all project at the same side of the contact element.

6. A fuel cell unit in accordance with claim 2, wherein the boundary portions project at two mutually opposite sides of the contact element.

7. A fuel cell unit in accordance with claim 6, wherein the break-throughs with boundary portions which project towards at a first side of the contact element are arranged in a first lattice, and wherein the break-throughs with boundary portions which protrude at the second side of the contact element opposite the first side are arranged in a second lattice.

8. A fuel cell unit in accordance with claim 7, wherein the break-throughs of the second lattice are arranged in the spaces between the break-throughs of the first lattice.

9. A fuel cell unit in accordance with claim 8, wherein the break-throughs of the second lattice are arranged substantially centrally between the respective neighboring break-throughs of the first lattice.

10. A fuel cell unit in accordance with claim 2, wherein the height of the projection of the boundary portions above the plate amounts to from approximately 0.5 mm up to approximately 2 mm.

11. A fuel cell unit in accordance with claim 2, wherein the height of the projection of the boundary portions above the plate amounts to from approximately the single thickness of the plate up to approximately five times the thickness of the plate.

12. A fuel cell unit in accordance with claim 2, wherein the height of the projection of the boundary portions above the plate is calibrated at a substantially uniform height.

13. A fuel cell unit in accordance with claim 1, wherein the contact element is in the form of a pointed plate.

14. A fuel cell unit in accordance with claim 1, wherein the surface density of the breakthroughs on the contact element amounts to approximately one break-through per cm² up to approximately 50 break-throughs per cm².

15. A fuel cell unit in accordance with claim 1, wherein the average distance between the center points of mutually neighboring break-throughs amounts to approximately 1 mm up to approximately 5 mm.

16. A fuel cell unit in accordance with claim 1, wherein the break-throughs are arranged in a grid pattern.

17. A fuel cell unit in accordance with claim 16, wherein the break-throughs are arranged in a square lattice or in a diamond lattice.

18. A fuel cell unit in accordance with claim 1, wherein the plate has a material thickness of from approximately 0.1 mm up to approximately 0.5 mm.

19. A fuel cell unit in accordance with claim 1, wherein the plate is formed from a metallic material.

20. A fuel cell unit in accordance with claim 19, wherein the plate is formed from a steel material.

21. A fuel cell unit in accordance with claim 20, wherein the plate is formed from a high temperature corrosion resistant steel material.

22. A fuel cell unit in accordance with claim 1, wherein the contact element is inserted loosely between the cathode electrolyte anode unit and a housing-part of a housing of the fuel cell unit.

23. A fuel cell unit in accordance with claim 1, wherein the contact element is fixed to a housing-part of a housing of the fuel cell unit

24. A fuel cell unit in accordance with claim 23, wherein the contact element is soldered and/or welded to a housing-part of a housing of the fuel cell unit.

25. A fuel cell unit in accordance with claim 1, wherein at least one contact element is arranged on the anode side of the cathode electrolyte anode unit.

26. A fuel cell unit in accordance with claim 1, wherein at least one contact element is arranged on the cathode side of the cathode electrolyte anode unit.

27. A fuel cell stack comprising a plurality of fuel cell units in accordance with claim 1 which succeed one another in the direction of the stack.
